(19) United States
(12) Patent Application Publication
(10) Pub. No.: US 2010/0284491 A1
(43) Pub. Date: Nov. 11, 2010

(54) Method and Apparatus for Obtaining Symbol Mapping Diversity, Creating Constellation Map, and Modulating

(75) Inventors: Dageng Chen, Shenzhen (CN); Yi Wang, Shenzhen (CN)

Correspondence Address: Slater & Matsil, L.L.P., 17950 Preston Road, Suite 1000, Dallas, TX, 75252, US

(73) Assignee: HUAWEI TECHNOLOGIES CO., LTD., Shenzhen (CN)

(21) Appl. No.: 12/842,757

(22) Filed: Jul. 23, 2010

Related U.S. Application Data
(63) Continuation of application No. PCT/CN2009/070045, filed on Jan. 6, 2009.

(30) Foreign Application Priority Data
Jan. 24, 2008 (CN) 200810000246.3
Jun. 27, 2008 (CN) 200810127548.7

(51) Int. Cl. H04L 27/20

(52) U.S. Cl. 375/308

(57) ABSTRACT

A method and apparatus for obtaining a Symbol Mapping Diversity (SMD), creating a constellation map, and modulating are disclosed.

This application is a continuation of co-pending International Application No. PCT/CN2009/070045, filed Jan. 6, 2009, which designated the United States and was not published in English, and which claims priority to Chinese Application Nos. 200810000246.3, filed Jan. 24, 2008 and 200810127548.7, filed Jun. 27, 2008, each of which is incorporated herein by reference.

### TECHNICAL FIELD

The present invention relates to communication technologies, and in particular, to a method and apparatus for obtaining a Symbol Mapping Diversity (SMD), creating a constellation map and modulating.

### BACKGROUND

In current communication systems, Phase-Shift Keying (PSK) and Quadrature Amplitude Modulation (QAM) are the most widely used modulation technologies.

In terms of multilayer modulation, the purpose of high-order QAM is to increase distance between constellation points and reduce the crosstalk between constellation points. In a high-order modulation scheme, such as 16QAM, a bit stream is usually mapped to a constellation map via unequal power mapping, which maps some bits to constellation points of higher power and map other bits to constellation points of lower power.

The prior art provides a 16QAM method. As shown in FIG. 1, the method includes: performing serial-parallel conversion on an input bit stream and mapping the converted bit stream to different layers for modulation; performing Quadrature Phase-Shift Keying (QPSK) modulation on bit stream of first layer and multiplying the QPSK-modulated symbol amplitude by 2; performing QPSK modulation on bit stream of second layer and multiplying the modulated symbol amplitude by 1; and superposing the amplitude-adjusted symbols to create 16QAM symbols. In the 16QAM scheme, the purpose of the two-layer unequal power distribution of bit streams is to increase distance between constellation points and reduce crosstalk between constellation points.

FIG. 2 gives a 16QAM constellation map in the prior art. In FIG. 2, circles in solid lines represent the 16QAM constellation map. For description purposes, it is assumed that the constellation points corresponding to the symbols output by QPSK modulation in FIG. 1 are ±1±j. Then the constellation points corresponding to the output symbols with amplitude 2 in the first layer are ±2±2j, in a one-to-one mapping with the four circles in broken lines in FIG. 2. The constellation points corresponding to the output symbols with amplitude 1 in the second layer are ±1±j. Through superposition processing, the symbols are mapped to four new rectangular coordinate systems which take the four broken circles as origins of the new coordinate systems and thus a 16QAM constellation map is created.

The origins of the new rectangular coordinate systems are ±2±2j away from origin of the rectangular coordinate system of the first-layer QPSK symbols. The four solid circles adjacent to each broken circle with an equal distance make up constellation map of the second-layer QPSK symbols.

During the implementation of the present invention, however, the inventor finds at least the following problem in the prior art: The constellation map of high-order QAM is created via unequal power mapping, where bits transmitted over the low power layer of a channel may be easily affected by channel fading and noise; as a result, Block Error Rate (BLER) at terminal receiver is high.

### SUMMARY OF THE INVENTION

One purpose of embodiments of the present invention is to provide a modulating method and apparatus which can reduce BLER at a terminal.

Another purpose of embodiments of the present invention is to provide a transmitter which can reduce the BLER at a terminal.

Another purpose of embodiments of the present invention is to provide a method and apparatus for obtaining an SMD, where the method and apparatus can eliminate inter-layer interference caused by superposition during retransmission and obtain the SMD.

Another purpose of embodiments of the present invention is to provide a system for obtaining the SMD, where the system can eliminate inter-layer interference caused by superposition during retransmission and obtain the SMD.

For the purposes above, embodiments of the present invention provide technical solutions as follows.

A method for creating a constellation map includes modulating an input bit stream of each layer with a same modulation scheme to obtain basic modulated symbols of the input bit stream of each layer. A phase shift is performed on constellation maps corresponding to the basic modulated symbols of the input bit streams of at least two layers with different phase-shift factors. The phase-shifted constellation maps corresponding to the basic modulated symbols of the input bit streams of the at least two layers are superimposed.

A modulating method includes modulating an input bit stream of each layer with a same modulation scheme to obtain basic modulated symbols of the input bit stream of each layer. A phase shift is performed on the basic modulated symbols of the input bit streams of at least two layers with different phase-shift factors. The phase-shifted the basic modulated symbols of the input bit streams of the at least two layers are superimposed.

A modulating apparatus includes at least two basic modulating units that are configured to modulate an input bit stream of each layer with a same modulation scheme to obtain basic modulated symbols of the bit stream of each layer. At least two phase shifting units are configured to perform phase shift on the basic modulated symbols of the input bit streams of at least two layers with different phase-shift factors, wherein the number of the phase shifting units are the same as the number of the basic modulating units. A superposing unit is configured to superpose the phase-shifted basic modulated symbols of the input bit streams of the at least two layers.

A transmitter includes a channel coding unit are configured to perform redundancy coding on input bit streams with a coding scheme and output the coded bit streams to a modulating apparatus. The coding scheme of the redundancy coding is a low density parity check code, a Turbo codesor a convolutional code. The modulating apparatus is configured to perform serial-parallel conversion on the coded bit streams output by the channel coding unit and output the converted bit streams to different layers, to modulate the converted input bit stream of each layer with a same modulation scheme to obtain basic modulated symbols of the converted input bit stream of each layer, to perform phase shift on the basic modulated symbols of the converted input bit streams of the at least two layers respectively with different phase-shift factors to obtain modulated symbols of the converted input bit streams of at least two layers, and to superpose the modulated symbols of the converted input bit streams of the at least two layers.

A method for obtaining an SMD includes receiving indication information indicating that retransmission is required, where the indication information is sent by a terminal if an error is detected in a transmission of a transmitted signal. Angle rotational superposition is performed on basic modulated symbols of the transmitted signal to obtain a signal for retransmission, where the rotational superposition angle used to obtain the basic modulated symbols of the signal for retransmission is different from that used to obtain the basic modulated symbols of the transmitted signal. The signal for retransmission is transmitted to the terminal, which processes the transmitted signal and the retransmitted signal jointly to obtain the SMD.

A system for obtaining an SMD includes an Angle Rotational Superposition Modulation (ARSM) apparatus connected to a terminal in a communicable way. The ARSM apparatus is configured to receive information which indicates that retransmission is required, where the information is sent by a terminal if an error is detected in a transmission of the transmitted signal, to perform angle rotational superposition on basic modulated symbols of the transmitted signal to obtain a signal for retransmission, where the rotational superposition angle used to obtain the basic modulated symbols of the signal for retransmission is different from that used to obtain the basic modulated symbols of the transmitted signal, and to transmit the signal for retransmission to the terminal, which processes the transmitted signal and the retransmitted signal jointly to obtain the SMD.

An ARSM apparatus includes a receiving module that is configured to receive information which indicates that retransmission is required. The information is sent by a terminal if an error is detected in a transmission of the transmitted signal. An angle rotational superposing module is configured to perform rotational superposition on basic modulated symbols of the transmitted signal according to the indication received by the receiving module to obtain a signal for retransmission. The rotational superposition angle used to obtain the basic modulated symbols of the signal for retransmission is different from that used to obtain the basic modulated symbols of the transmitted signal. A transmitting module is configured to transmit the signal for retransmission to the terminal.

The technical solutions provide the following advantages or benefits.

Bit streams are modulated with a same modulation scheme and phase shift is performed on the basic modulated symbols of at least two layers according to different phase-shift factors. Thus, equal power ARSM is implemented in at least two layers. The BLER at the receiver is therefore reduced.

The transmitter in the embodiments of the present invention modulates bit streams with a same modulation scheme to obtain basic modulated symbols and performs phase shift on the basic modulated symbols of at least two layers according to different phase-shift factors. Thus, equal power ARSM is implemented in at least two layers. The BLER at the receiver is therefore reduced.

With the ARSM method, system and apparatus provided in the embodiments of the present invention, rotational superposition is performed on the basic modulated symbols of the transmitted signal requiring retransmission to obtain the signal for retransmission. The rotational superposition angle used to obtain the signal for retransmission is different from that used to obtain the transmitted signal. Thus, the receiver can process the received transmitted signal and retransmitted signal jointly and therefore inter-layer interference caused by superposition can be eliminated effectively and the SMD can be obtained.

### BRIEF DESCRIPTION OF THE DRAWINGS

FIG. 1 shows a 16QAM scheme in the prior art;

FIG. 2 shows a 16QAM constellation map in the prior art;

FIG. 3 shows a modulating apparatus in a first embodiment of the present invention;

FIG. 4 shows a transmitter in a second embodiment of the present invention;

FIG. 5 shows a transmitter in a third embodiment of the present invention;

FIG. 6a shows a constellation map created in a fourth embodiment of the present invention;

FIG. 6b shows a constellation map created in the fourth embodiment of the present invention;

FIG. 6c shows a constellation map created in the fourth embodiment of the present invention;

FIG. 7 shows a flowchart of a modulating method in a fifth embodiment of the present invention;

FIG. 8 shows a structure of an improved modulating method in an embodiment of the present invention;

FIG. 9 shows a performance curve of ARSM in an embodiment of the present invention and a performance curve of conventional 16QAM;

FIG. 10 shows a flowchart of a method for obtaining an SMD in an embodiment of the present invention;

FIG. 11 shows a structure of an ARSM apparatus in an embodiment of the present invention; and

FIG. 12 shows a structure of a transmit diversity modulating apparatus in an embodiment of the present invention.

### DETAILED DESCRIPTION OF ILLUSTRATIVE EMBODIMENTS

The embodiments of the present invention provide a method for creating a constellation map, a method and apparatus for modulating and a transmitter. The embodiments of the present invention help reduce the BLER of a terminal. Some other embodiments of the present invention provide a method, apparatus and system for obtaining a Symbol Mapping Diversity (SMD). For easy understanding of the embodiments of the present invention, the embodiments will be described with reference to the accompanying drawings.

A modulating apparatus provided in an embodiment of the present invention includes at least two basic modulating units that are configured to modulate input bit streams with a same modulation scheme to obtain basic modulated symbols. At least two phase shifting units are configured to perform phase shift on basic modulated symbols of at least two layers output by the basic modulating unit according to different phase-shift factors. The number of the phase shifting units is the same as the number of the basic modulating units. A superposing unit is configured to superpose the modulated symbols output by at least two of the phase shifting units.

In the embodiment of the present invention, basic modulated symbols of at least two layers are phase-shifted according to different phase-shift factors. Thus, equal power ARSM is implemented in at least two layers. The BLER at the terminal is therefore reduced.

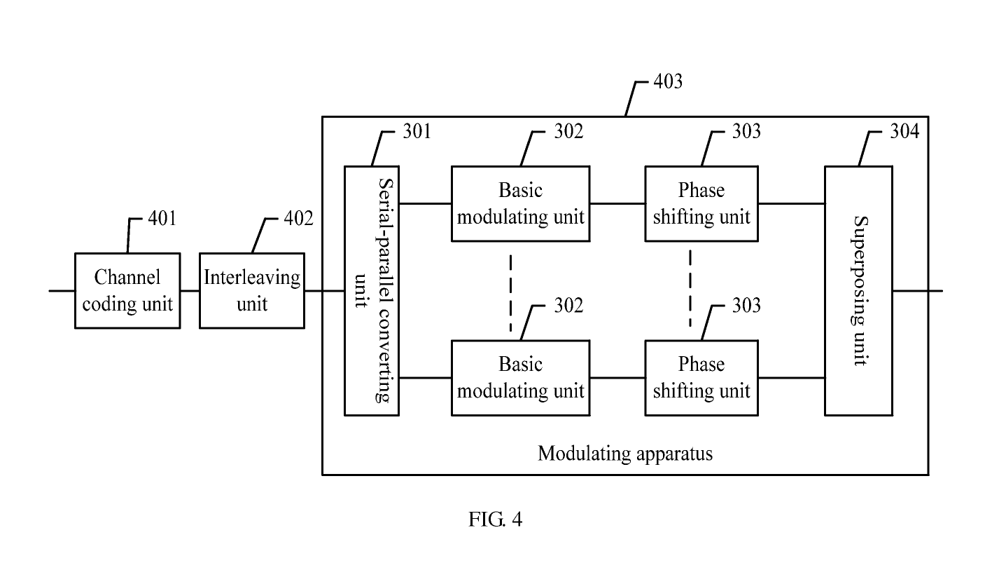

The first embodiment provides a modulating apparatus. As shown in FIG. 3, the apparatus includes a serial-parallel converting unit 301, basic modulating units 302, phase shifting units 303, and a superposing unit 304.

The serial-parallel converting unit 301 is configured to perform serial-parallel conversion on input bit streams and distribute the converted bit streams to basic modulating units 302 of different layers.

The basic modulating units 302 are configured to modulate the bit streams output by the serial-parallel converting unit 301 with a same modulation scheme, such as equal power Binary Phase Shift Keying (BPSK) or QPSK. There are at least two basic modulating units. BPSK is a special application of QPSK. A QPSK symbol may be created by superposing two BPSK symbols whose phase difference is π/2.

The phase shifting units 303 are configured to perform phase shift on the basic modulated symbols output by the basic modulating units 302 according to different phase-shift factors, which usually differentiate different layers. The number of phase shifting units is the same as the number of basic modulating units. The phase-shift factor is expressed by

exp(j*φ),

where φ represents the shift phase.

exp(j*φ)=e^{iφ}=cos φ+j sin φ.

The superposing unit 304 is configured to superpose the symbols output by the phase shifting unit 303 of each layer, thus completing the ARSM.

In the embodiment of the present invention, the modulating apparatus performs phase shift on the basic modulated symbols of at least two layers according to different phase-shift factors. Thus, equal power ARSM is implemented in at least two layers. The BLER at the terminal is therefore reduced.

It should be noted that the bit streams in the first embodiment of the present invention are the data streams of one service of one user.

The modulating apparatus in the first embodiment of the present invention may be implemented in the form of hardware or in form of software functions. The apparatus in the first embodiment of the present invention may be sold or used as an independent product or stored in a compute readable medium as a program.

In the first embodiment, different phase-shift factors are adopted to differentiate at least two layers. The differentiation of the remaining layers is not limited to the phase-shift factor. The remaining layers may be differentiated by power or other means.

The serial-parallel converting unit distributes the input streams to different layers. An interleaving unit may be adopted in each layer to rearrange the input streams according to a certain rule and then send the rearranged bit streams to the basic modulating units.

The apparatus in the first embodiment of the present invention is based on ARSM. It can create multiple types of ARSM-modulated constellation maps. Such constellation maps may be applied in different communication systems as the supplement to or substitute for PSK/QAM in the prior art.

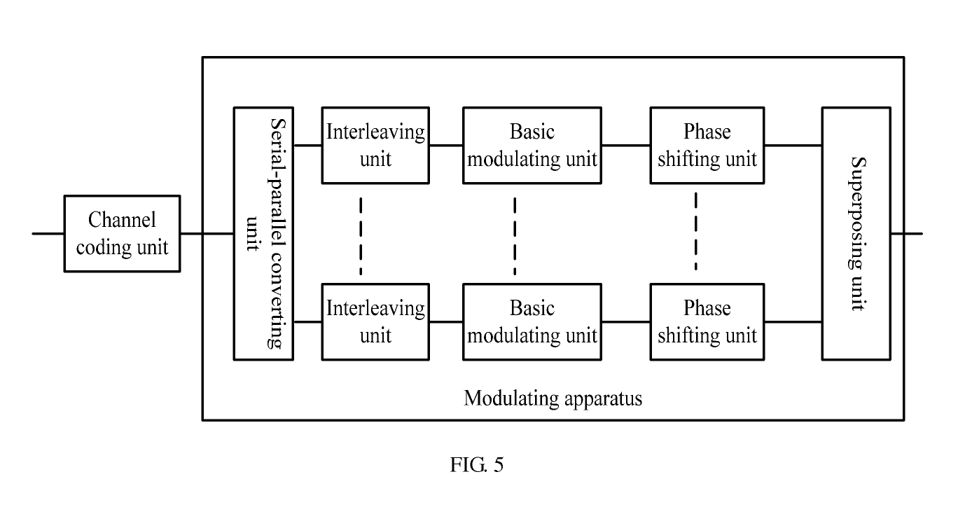

A transmitter is provided in the second embodiment of the present invention. As shown in FIG. 4, the transmitter includes a channel coding unit 401, an interleaving unit 402, and a modulating apparatus 403.

The channel coding unit 401 is configured to perform redundancy coding on received data streams. The coding scheme of the redundancy coding usually includes low density parity check codes, Turbo codes or convolutional codes.

The interleaving unit 402 is configured to rearrange the bit streams output by the channel coding unit 401 according to a certain rule.

The modulating apparatus 403 is configured to perform serial-parallel conversion on the bit streams output by the interleaving unit 402, distribute the converted bit streams to different layers, modulate the bit streams of different layers to obtain basic modulated symbols, perform phase shift on the basic modulated symbols output by at least two layers according to different phase-shift factors, and superpose the phase-shifted symbols of each layer.

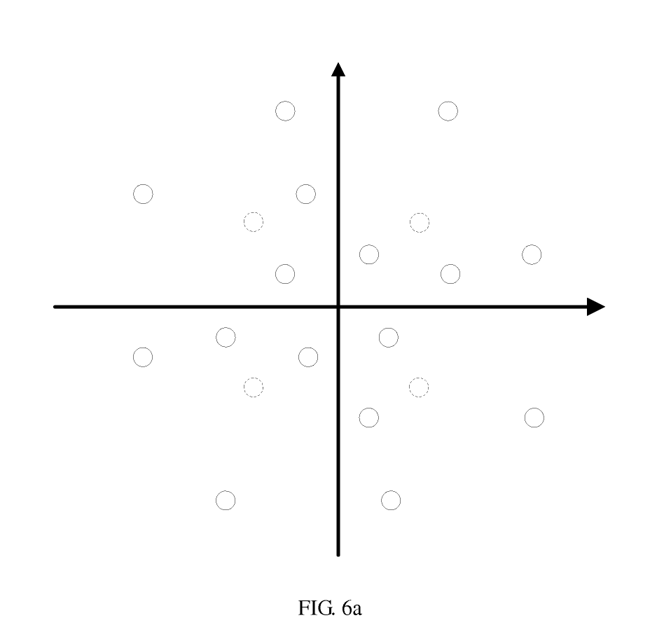

A transmitter provided in the third embodiment of the present invention, as shown in FIG. 5, is different from that in the second embodiment as follows:

The interleaving unit is built in the modulating apparatus. The modulating apparatus performs serial-parallel conversion on the bits output by the channel coding unit and distributes the converted bit streams to different layers. Different interleaving units rearrange the bit streams in different layers. Then the modulating apparatus performs ARSM on the rearranged bit streams.

In the second and third embodiments of the present invention, the transmitter includes a modulating apparatus. The basic modulated symbols of at least two layers are phase-shifted according to different phase-shift factors. Thus, equal power ARSM is implemented in at least two layers. The BLER at the terminal is therefore reduced.

The fourth embodiment of the present invention provides a method for creating a constellation map. The method includes the following steps:

modulating the input bit stream of each layer with a same modulation scheme such as equal power BPSK or QPSK to obtain basic modulated symbols;

performing phase shift on the constellation maps corresponding to the basic modulated symbols output by at least two layers according to different phase-shift factors; and

superposing the phase-shifted constellation maps of different layers to create a constellation map for mapping.

In the fourth embodiment of the present invention, phase shift is performed on the constellation maps corresponding to the basic modulated symbols output by at least two layers according to different phase-shift factors. Then, a constellation map for mapping can be obtained by superposing the phase-shifted constellation maps of different layers.

It should be noted that the shift phases of the constellation maps corresponding to the basic modulated symbols output by at least two layers are different. Generally, the phase difference is larger than zero or smaller than zero.

The following description is an example based on two-layer ARSM. Suppose the spectrum efficiency is 4, which means each symbol includes four bits, and equal power QPSK is adopted for basic modulation in each layer. The phase corresponding to the phase-shift factor of the first layer is φ1 and the phase corresponding to the phase-shift factor of the second layer is φ2.

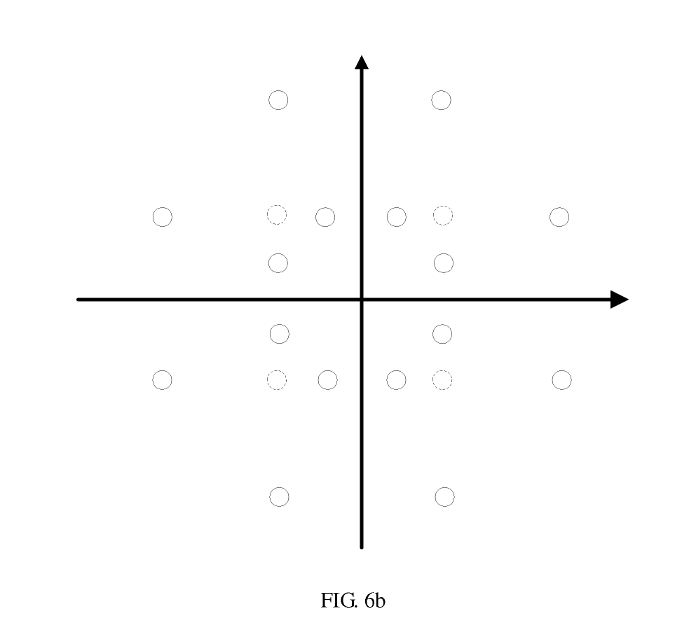

The constellation map corresponding to the basic modulated symbols output by the first layer is shifted by φ1 and the constellation map corresponding to the basic modulated symbols output by the second layer is shifted by φ1. Then the constellation maps obtained after phase shift in the two layers are superposed. When the shift angle of the first layer is 0, the shift angle of the second layer is π/6, and the shift phase difference between the two layers is |φ1−φ2|=π/6, the created constellation map is shown in FIG. 6a, where the broken circles represent the constellation map with QPSK/4QAM adopted for basic modulation in each layer. When the shift angle of the first layer is 0, the shift angle of the second layer is π/4, and the shift phase difference between the two layers is |φ1−φ2|=π/4, the created constellation map is shown in FIG. 6b, where the broken circles represent the constellation map with QPSK/4QAM adopted for basic modulation in each layer.

It should be noted that when the symbols output after phase shift in two or more layers are superposed, the shift phase may vary each time. But, so long as the phase difference between every two layers is fixed, the obtained constellation map is fixed.

Take the constellation map obtained through two-layer ARSM with QPSK adopted for basic modulation as an example. As shown in FIG. 6c, the shift angle of the first layer is π/12, the shift angle of the second layer is −π/12, and the phase difference is π6. The constellation map can also be obtained by rotating the map shown in FIG. 6a clockwise by π/12. The constellation map shown in FIG. 6c is equivalent to the constellation map shown in FIG. 6a. The difference is that the origin in FIG. 6c is shifted from that in FIG. 6a by π/12.

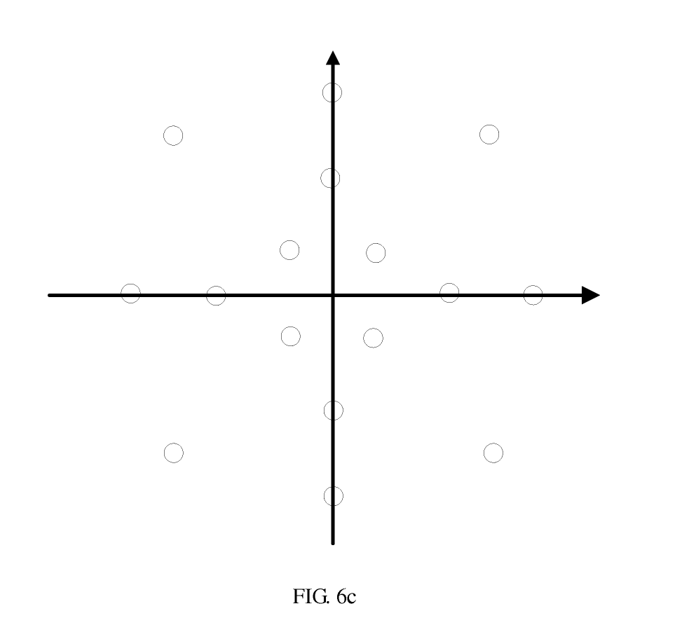

The fifth embodiment of the present invention provides a modulating method. FIG. 7 shows a procedure of the method, including the following steps.

Step 701: Performing serial-parallel conversion on input bit streams and distribute the converted bit streams to different layers, where the bit streams are the data streams of one service of one user.

Optionally, the input bit streams may be replicated and the replicated streams are distributed to different layers.

Step 702: Modulating the input bit stream of each layer with a same modulation scheme to obtain basic modulated symbols. Generally equal power BPSK or QPSK modulation is adopted. QPSK is a special application of BPSK. A QPSK symbol may be obtained by superposing two BPSK symbols, whose phase difference is π/2.

Optionally, before modulating the bit streams, the procedure further includes: rearranging the input bit streams.

Step 703: Performing phase shift on the basic modulated symbols output by at least two layers according to different phase-shift factors.

Step 704: Superposing the symbols output after phase shift in each layer to complete the ARSM.

Therefore, in the fifth embodiment, phase shift is performed on the basic modulated symbols of at least two layers according to different phase-shift factors. Thus, equal power ARSM is implemented for the basic modulation in at least two layers. The BLER at the terminal is therefore reduced.

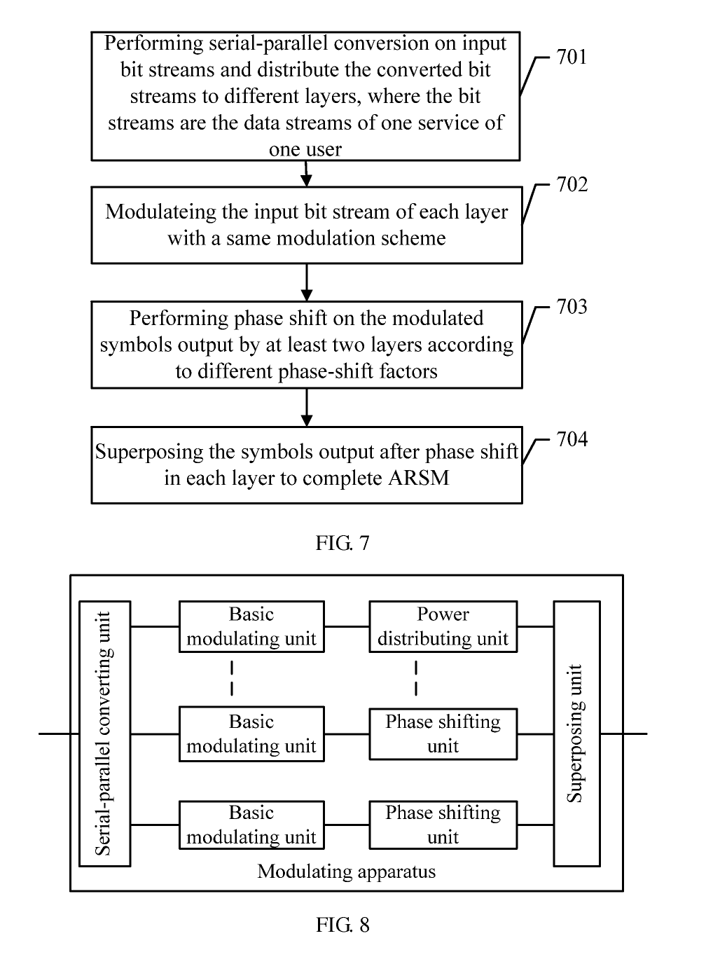

It should be noted when three or more layers are divided and phase shift is not performed on the basic modulated symbols output by all layers, the modulated symbols output by the remaining layers can be further modulated by using different power or any other means. As shown in FIG. 8, the basic modulated symbols output by at least two layers are further modulated by using a phase shifting unit and the basic modulated symbols output by other layers are further modulated by using a power distributing unit.

In addition, because the modulated symbols of each layer are processed differently, it is convenient to demodulate the modulated symbols of each layer to obtain the original input bit stream of each layer.

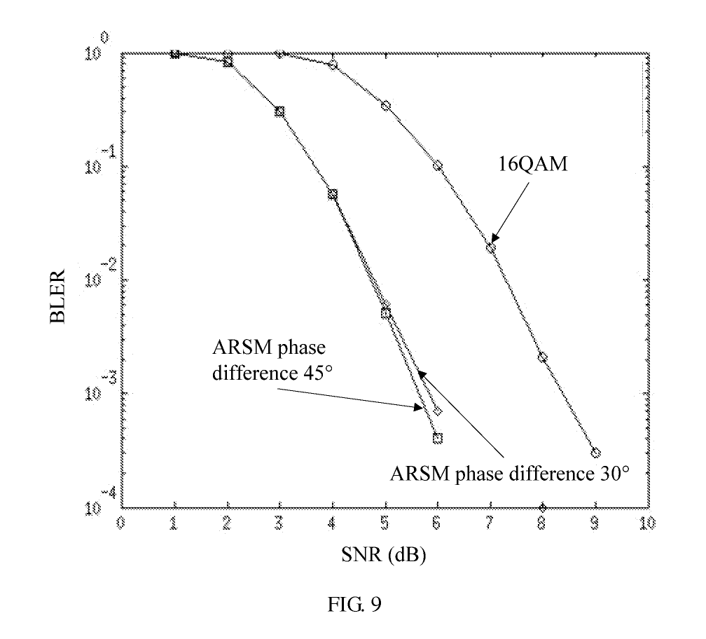

Finally, because ARSM is performed on at least two layers, the transmitted bits are more noise-resisting. For example, FIG. 9 shows the modulation of 16QAM symbols implemented by two-layer ARSM. When the phase difference between two layers is π/6 or π/4 and the Signal to Noise Ratio (SNR: Eb/No) is 3.7 dB, the BLER at the terminal can be down to 0.1. In the case of conventional 16QAM, the BLER of a terminal can reach 0.1 only when the SNR is 6 dB. The former SNR is 2.3 dB lower than the latter one.

Those skilled in the art may understand that all or part of the steps of the method in the above embodiment of the present invention may be implemented by hardware under instruction of a program. The program may be stored in a non-transitory computer-readable storage medium. When being executed, the program performs the following steps:

modulating the input bit stream of each layer with a same modulation scheme to obtain modulated symbols;

performing phase shift on the constellation maps corresponding to the modulated symbols output by at least two layers according to different phase-shift factors; and

superposing the phase-shifted constellation maps of different layers to create a constellation map for mapping.

Another embodiment program, when being executed, performs the following steps:

modulating the input bit stream of each layer with a same modulation scheme to obtain modulated symbols;

performing phase shift on the modulated symbols output by at least two layers according to different phase-shift factors; and

superposing the modulated symbols output by each layer after the phase shift.

The storage medium may be a Read-Only Memory (ROM), a Random Access Memory (RAM), a magnetic disk or a Compact Disk (CD).

The method for creating a constellation map, the modulating method and apparatus, and the transmitter provided in the embodiments of the present invention are described above in detail. The following describes a method for obtaining the SMD during signal retransmission in an ARSM system provided in an embodiment of the present invention.

The retransmission means retransmission of signals upon a transmission error. In Hybrid Automatic Repeat Request (HARQ) mode, the simplest retransmission is Chase Combining (CC), where the same signal is retransmitted after a transmission error. The SMD is a technology where the mapping from bits to symbols is changed during the retransmission with high-order QAM so that bits in different transmission processes have different reliability features and thus a transmit diversity is obtained.

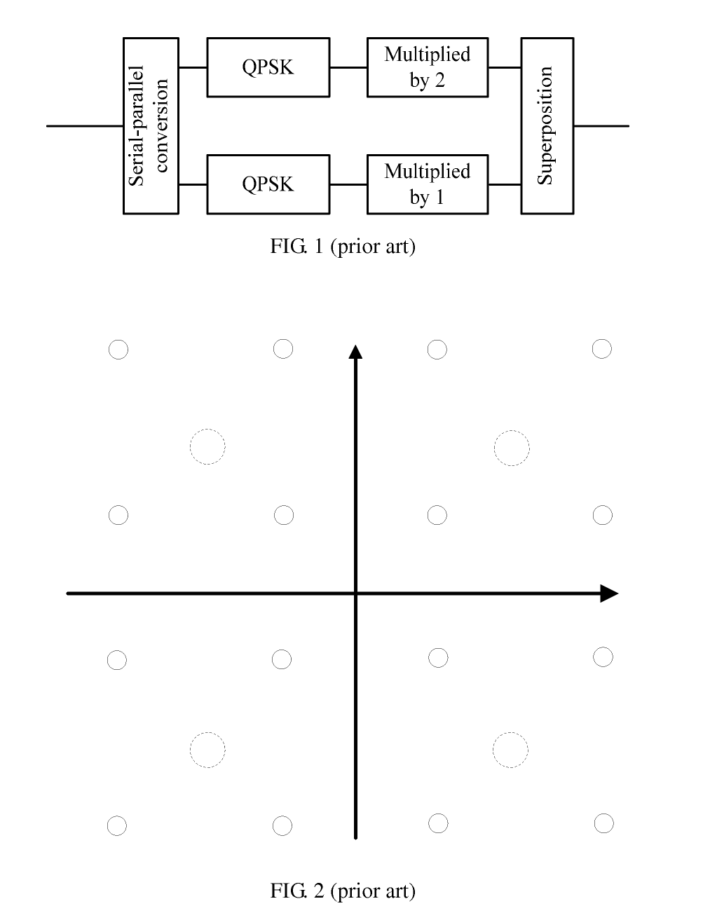

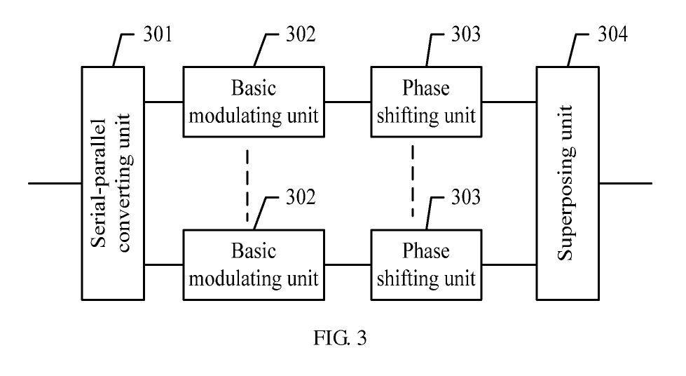

In an existing high-order QAM system, such as the 16QAM system shown in FIG. 1, because of the superposition of two layers of unequal power QPSK, two bits will have high reliability and two bits will have low reliability. Take b₁b₂b₃b₄ as an example. Suppose b₁b₂ are two bits of high reliability and b₃b₄ are two bits of low reliability. When a transmission error occurs and retransmission is required, the high-reliability bits of the last transmission are transmitted in the low-reliability places and the low-reliability bits of the last transmission are transmitted in the high-reliability places. That is, b₁b₂b₃b₄ is transmitted at the first time and b₃b₄b₁b₂ is transmitted at the second time to obtain the SMD.

In an ARSM system provided in the embodiments of the present invention, the SMD and inter-layer interference are mutually convertible. Obtaining the total SMD means the total elimination of inter-layer interference. Accordingly, the total elimination of inter-layer interference means obtaining the total SMD. During the first transmission, the inter-layer interference resulting from superposition can be eliminated only through iterative detection by the receiver. During the retransmission, the retransmitted signal may be changed before the retransmission so that the receiver can process the received signals jointly to reduce or eliminate inter-layer interference and obtain the SMD.

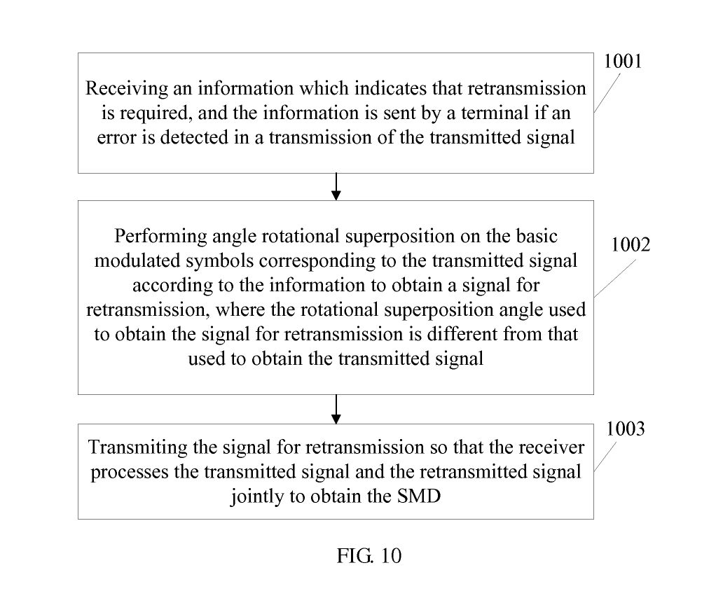

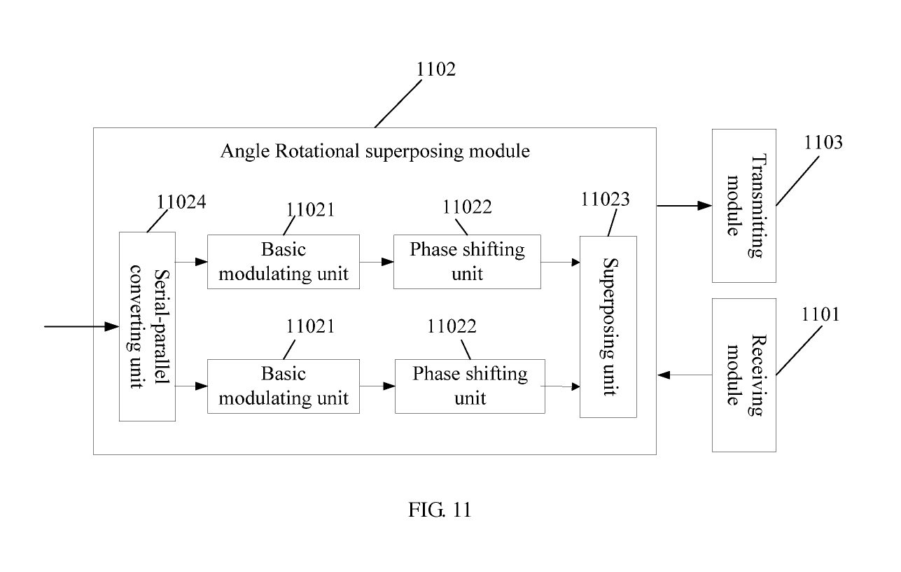

FIG. 10 gives a flowchart of the method for obtaining the SMD with the ARSM system provided in the embodiment of the present invention. FIG. 11 shows the structure of another modulating apparatus provided in an embodiment of the present invention. The method includes the following steps.

Step 1001: Receiving information which indicates that retransmission is required, and the information is sent by a terminal if an error is detected in a transmission of the transmitted signal.

When the terminal receives the signal transmitted from the ARSM system, if the terminal fails to decode the signal correctly, the terminal determines an error in the transmission of the transmitted signal and requests the ARSM system to retransmit the signal. Suppose, during the first transmission, the respective phase-shift factors selected by two phase shifting units 113 in the ARSM apparatus are: {exp*(j*φ11), exp(j*φ12)}. For description purposes, it is assumed that φ11=0 and φ12=θ₁. After superposition, the first transmitted signal is:

x₁=s₁+s₂*e^{j*θ}^{₁},s₁,s₂εQPSK (1)

Step 1002: Performing angle rotational superposition on the basic modulated symbols corresponding to the transmitted signal according to the information to obtain a signal for retransmission. The rotational superposition angle used to obtain the signal for retransmission is different from that used to obtain the transmitted signal.

In particular, step 1002 includes:

modulating the bit streams of two layers of the transmitted signal with a same modulation scheme to obtain the basic modulated symbols of two layers;

performing phase shift on the basic modulated symbols of the two layers with phase shift factors different from those used to obtain the transmitted signal to obtain modulated symbols of the two layers; and

superposing the phase-shifted modulated symbols of the two layers to obtain the signal for retransmission.

The same modulation scheme used to modulate the input bit streams of two layers is usually equal power BPSK or QPSK. QPSK is a special application of BPSK. A QPSK symbol may be the superposition of two BPSK symbols whose phase difference is π/2.

Suppose, during the retransmission, the respective phase-shift factors selected by two phase shifting units 113 in the ARSM apparatus are: {exp(j*f11), exp(j*f12)}. For description purposes, it is assumed that φ21=0 and φ22=θ₂. After superposition, the retransmitted signal is:

x₂=s₁+s₂*e^{j*θ}^{₂},s₁,s₂εQPSK (2)

Step 1003: Transmitting the signal for retransmission so that the terminal processes the transmitted signal and the retransmitted signal jointly to obtain the SMD. Upon reception of the retransmitted signal, the terminal processes the transmitted signal and the retransmitted signal jointly to obtain the SMD.

The terminal can combine the two signals to:

$$[ \begin{matrix}{y}_{1} \\ {y}_{2}\end{matrix} ] = [ \begin{matrix}1 & {e}^{j * {θ}_{1}} \\ 1 & {e}^{j * {θ}_{2}}\end{matrix} ] [ \begin{matrix}{s}_{1} \\ {s}_{2}\end{matrix} ] + [ \begin{matrix}{n}_{1} \\ {n}_{2}\end{matrix} ] \qquad ( 3 )$$

where, n₁, n₂ are noise signals during the first transmission and the second transmission and are subject to the Gaussian distribution with the mean value 0 and the variance σ², that is n₁, n₂εN(0,σ²).

The terminal solves the equation (3) so that the SNR of the received signal is obtained:

SNR(s₁)=Eₛ/{2σ²/|e^{j*θ}^{₂}−e^{j*θ}^{₁}|²} (4)

SNR(s₂)=Eₛ/{2σ²/|e^{j*θ}^{₂}−e^{j*θ}^{₁}|²} (5)

where, Eₛ is the modulation power of S₁ and S₂.

To maximize the SNR of the received signal, (4) and (5) may be combined to obtain θ₂=θ₁+π, when:

SNR(s₁)=SNR(s₂)=2Eₛ/σ²=E(x₁)/σ²=E(x₂)/σ² (6)

From (6), it is known that the transmit energy of the ARSM system during the retransmission is all used to transmit the signal and that inter-layer interference is eliminated. This means adjusting the superposition angle of the signal can eliminate the inter-layer interference caused by superposition and obtain the total SMD.

It should be noted that the bit streams in the embodiment of the present invention are the data streams of one service of one user.

The foregoing deduction and calculation are familiar to those skilled in the art. Therefore, the deduction is not explained in detail in the embodiment of the present invention.

The method for obtaining the SMD provided in the embodiment of the present invention is described with reference to the accompanying drawing. The following will describe another ARSM apparatus provided in an embodiment of the present invention. FIG. 11 shows a structure of the ARSM apparatus provided in the embodiment of the present invention. The modulating apparatus includes a receiving module 1101 that is configured to receive information which indicates that retransmission is required, and the information is sent by a terminal if an error is detected in a transmission of the transmitted signal.

An angle rotational superposing module 1102 is configured to perform angle rotational superposition on the basic modulated symbols of the transmitted signal according to the information received by the receiving module 1101 to obtain a signal for retransmission. The rotational superposition angle used to obtain the signal for retransmission is different from the rotational superposition angle used to obtain the transmitted signal.

A transmitting module 1103 is configured to transmit the signal for retransmission obtained by the angle rotational superposing module 1102 so that the terminal processes the transmitted signal and the retransmitted signal jointly to obtain the SMD.

The angle rotational superposing module 1102 may further include two basic modulating units 11021, two phase shifting units 11022, and a superposing unit 11023.

The two basic modulating units 11021 are configured to modulate the bit streams of the transmitted signal according to the information received by the receiving module 1103 with a same modulation scheme to obtain basic modulated symbols, where the modulation scheme is usually equal power BPSK or QPSK.

The two phase shifting units 11022 are configured to perform phase shift on the basic modulated symbols of two layers with phase-shift factors different from those used to obtain the transmitted signal, where different layers are usually differentiated by different phase-shift factors. The phase-shift factor is expressed by exp(j*φ), where φ represents the shift phase. Here, exp(j*φ)=e^{iφ}=cos φ+j sin φ.

The superposing unit 11023 is configured to superpose the phase-shifted modulated symbols of the two layers to obtain a signal for retransmission and send the signal to the terminal.

The angle rotational superposing module 1102 may further include a serial-parallel converting unit 11024 that is configured to perform serial-parallel conversion on the bit streams of the transmitted signal and distribute the converted bit streams to the basic modulating units.

Therefore, in the solution provided by the embodiments of the present invention, equal power signals of two layers are superposed and transmitted. In the embodiment of the present invention, the modulating apparatus performs phase shift on the basic modulated symbols of two layers according to phase-shift factors different from those used to obtain the transmitted signal. Thus, equal power ARSM is implemented in two layers. The BLER at the terminal is therefore reduced.

The method for obtaining the SMD provided in the embodiment of the present invention may also be applied in an ARSM system based on the modulating apparatus shown in FIG. 8. The basic modulated symbols of two layers are further modulated by the phase shifting unit and the modulated symbols output by other layers may be further modulated by a power distributing unit.

It should be noted that the bit streams in the embodiment of the present invention are the data streams of one service of one user.

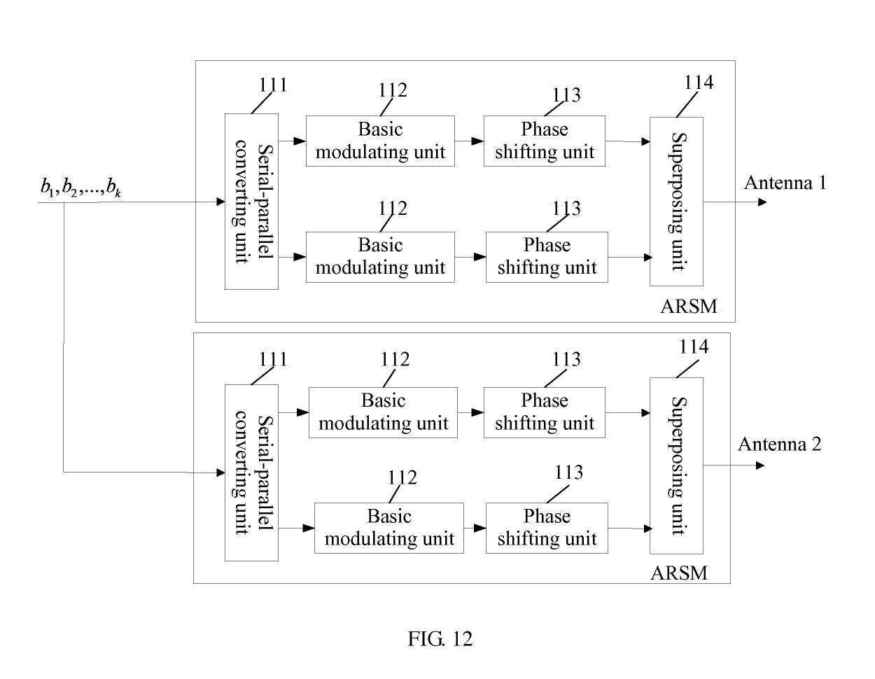

The angle rotational superposing module in the ARSM apparatus provided in the embodiment of the present invention shown in FIG. 11 may also be applied in the transmit diversity, as shown in FIG. 12. The angle rotational superposing modules of two ARSM apparatuses can constitute a modulating apparatus required by the transmit diversity. The composition of the modulating apparatus of the transmit diversity is the same as that of the angle rotational superposing module of the modulating apparatus shown in FIG. 11. The difference is that the modulating apparatus of the transmit diversity includes two angle rotational superposing modules of the modulating apparatus shown in FIG. 11. The modulating apparatus of the transmit diversity will therefore not be further described.

The method and apparatus for obtaining the SMD during retransmission are described above. With the method and apparatus, when a signal needs to be retransmitted, the superposition angle of the signal is adjusted so that the terminal processes two received signals jointly. Thus, the inter-layer interference caused by superposition can be eliminated and the SMD is obtained. A system provided in an embodiment of the present invention will be described with reference to the method and apparatus for obtaining the SMD provided in the embodiments of the present invention.

The system for obtaining the SMD provided in the embodiment of the present invention includes the ARSM apparatus shown in FIG. 11. The ARSM apparatus is connected to a terminal in a communicable way.

The ARSM apparatus is configured to receive information which indicates that retransmission is required, and the information is sent by a terminal if an error is detected in a transmission of the transmitted signal. The ARSM apparatus further performs angle rotational superposition on the basic modulated symbols of the transmitted signal according to the information to obtain the signal for retransmission, where the rotational superposition angle used to obtain the signal for retransmission is different from that used to obtain the transmitted signal. The ARSM apparatus transmits the signal for retransmission so that terminal processes the transmitted signal and the retransmitted signal jointly to obtain the SMD.

In particular, the step of performing angle rotational superposition on the basic modulated symbols of the transmitted signal according to the information to obtain the signal for retransmission, where the rotational superposition angle used to obtain the signal for retransmission is different from that used to obtain the transmitted signal, includes:

modulating the bit streams of two layers of the transmitted signal with a same modulation scheme to obtain basic modulated symbols of two layers;

performing phase shift on the basic modulated symbols of the two layers with phase shift factors different from those used to obtain the transmitted signal to obtain modulated symbols of the two layers; and

superposing the phase-shifted modulated symbols of the two layers to obtain the signal for retransmission.

Therefore, in the system for obtaining the SMD provided in the embodiment of the present invention, when a signal is retransmitted, the superposition angle of the signal is changed so that the terminal processes two received signals jointly. Thus, inter-layer interference caused by superposition is eliminated and the SMD is obtained.

A method for creating a constellation map, a modulating method and apparatus and a transmitter provided in the embodiments of the present invention are described above in detail. On such basis, a method, apparatus and system for obtaining the SMD are described. The principle and implementation of the present invention are described herein through specific examples. The description about the embodiments is merely provided for ease of understanding of the method and core ideas of the present invention. Those of ordinary skill in the art can make variations and modifications to the present invention in terms of the specific implementations and application scopes according to the ideas of the present invention. Therefore, the specification shall not be construed as limitations to the present invention.

What is claimed is:

1. A modulating method, comprising:
modulating an input bit stream of each layer with a common modulation scheme to obtain basic modulated symbols of the input bit stream of each layer;
performing a phase shift on the basic modulated symbols of the input bit streams of at least two layers with different phase-shift factors; and
superposing the phase-shifted basic modulated symbols of the input bit streams of the at least two layers.

2. The method of claim 1, wherein before modulating the input bit stream, the method further comprises rearranging the input bit stream of each layer.

3. The method of claim 1, wherein modulating the input bit stream comprises modulating the input bit stream of each layer with Binary Phase Shift Keying (BPSK) to obtain the basic modulated symbols of the input bit stream of each layer.

4. The method of claim 1, wherein modulating the input bit stream comprises modulating the input bit stream of each layer with Quadrature Phase-Shift Keying (QPSK) to obtain the basic modulated symbols of the input bit stream of each layer.

5. The method of claim 1, wherein, when there are input bit streams of three or more layers and phase shift is not performed on basic modulated symbols of input bit streams of all layers, the method further comprises:
modulating, with unequal power, the basic modulated symbols of the input bit stream(s) of layers where phase shift is not performed; and
superposing the basic modulated symbols of the input bit streams of all layers.

6. The method of claim 1, wherein the input bit streams comprise data streams of one service of one user.

7. A modulating apparatus, comprising:
at least two basic modulating units;
at least two phase shifting units; and
a superposing unit;
wherein each basic modulating unit is configured to modulate an input bit stream of a corresponding layer to obtain basic modulated symbols of the bit stream of the corresponding layer, wherein a modulation scheme is adopted by each basic modulating unit;
wherein each phase shifting unit is configured to perform phase shift on the basic modulated symbols of the input bit stream of the corresponding layer correspondingly output by each basic modulating unit with a phase-shift factor, wherein phase-shift factors adopted by each phase shifting unit are different from each other; and
wherein the superposing unit is configured to superpose the phase-shifted basic modulated symbols of the input bit streams of the layers correspondingly output by the phase shifting units.

8. The apparatus of claim 7, further comprising at least two interleaving units, wherein each interleaving unit is configured to rearrange an input bit stream of a layer and send the rearranged bit stream to the basic modulating units correspondingly.

9. The apparatus of claim 7, wherein the input bit streams are data streams of one service of one user.

10. A transmitter, comprising:
a channel coding unit; and
a modulating apparatus;
wherein the channel coding unit is configured to perform redundancy coding on input bit streams with a coding scheme and output the coded bit streams to a modulating apparatus, wherein the coding scheme of the redundancy coding comprises a low density parity check code, a Turbo code or a convolutional code; and
wherein the modulating apparatus is configured to:
perform serial-parallel conversion on the coded bit streams output by the channel coding unit and output the converted bit streams to different layers;
modulate the converted input bit stream of each layer with a same modulation scheme to obtain basic modulated symbols of the converted input bit stream of each layer;
perform phase shift on the basic modulated symbols of the converted input bit streams of at least two layer respectively with different phase-shift factors to obtain modulated symbols of the converted input bit streams of the at least two layers; and
superpose the modulated symbols of the converted input bit streams of the at least two layers.

11. The transmitter of claim 10, wherein the same modulation scheme comprises Binary Phase Shift Keying (BPSK), or Quadrature Phase-Shift Keying (QPSK).

12. A method for creating a constellation map, comprising:
modulating an input bit stream of each layer with a same modulation scheme to obtain basic modulated symbols of the input bit stream of each layer;
performing a phase shift on constellation maps corresponding to the basic modulated symbols of the input bit streams of at least two layers with different phase-shift factors; and
superposing the phase-shifted constellation maps corresponding to the basic modulated symbols of the input bit streams of the at least two layers.

13. The method of claim 12, wherein modulating the input bit stream comprises modulating the input bit stream of each layer with Binary Phase Shift Keying (BPSK) to obtain the basic modulated symbols of the input bit stream of each layer.

14. The method of claim 12, wherein modulating the input bit stream comprises modulating the input bit stream of each layer with Quadrature Phase-Shift Keying (QPSK) to obtain the basic modulated symbols of the input bit stream of each layer.

15. A method for obtaining a Symbol Mapping Diversity (SMD), the method comprising:
receiving indication information indicating that retransmission is required, wherein the indication information is sent by a terminal if an error is detected in a transmission of a transmitted signal;
performing angle rotational superposition on basic modulated symbols of the transmitted signal to obtain a signal for retransmission, wherein a rotational superposition angle used to obtain the basic modulated symbols of the signal for retransmission is different from that used to obtain the basic modulated symbols of the transmitted signal; and
transmitting the signal for retransmission to the terminal, which processes the transmitted signal and the retransmitted signal jointly to obtain the SMD.

16. The method of claim 15, wherein the step of performing angle rotational superposition on the basic modulated symbols of the transmitted signal to obtain the signal for retransmission comprises:
modulating the input bit streams of two layers of the transmitted signal with a same modulation scheme to obtain basic modulated symbols of the input bit streams of the two layers;
performing phase shift on the input basic modulated symbols of the two layers with phase-shift factors, wherein the phase-shift factors are different from those used to obtain the transmitted signal, to obtain modulated symbols of the input bit streams of the two layers; and
superposing the modulated symbols of the input bit streams of the two layers to obtain the signal for retransmission.

17. The method of claim 16, wherein the step of modulating the input bit streams of the two layers of the transmitted signal with the same modulation scheme to obtain the basic modulated symbols of the input bit streams of the two layers comprises:
modulating the input bit streams of the two layers of the transmitted signal with Binary Phase Shift Keying (BPSK) to obtain the basic modulated symbols of the input bit streams of the two layers; or
modulating the input bit streams of the two layers of the transmitted signal with Quadrature Phase-Shift Keying (QPSK) to obtain the basic modulated symbols of the input bit streams of the two layers.

18. An Angle Rotational Superposition Modulation (ARSM) apparatus, comprising:
a receiving module, configured to receive information which indicates that retransmission is required, wherein the information is sent by a terminal if an error is detected in a transmission of the transmitted signal;
an angle rotational superposing module, configured to perform angle rotational superposition on basic modulated symbols of the transmitted signal according to the indication received by the receiving module to obtain a signal for retransmission, wherein a rotational superposition angle used to obtain the basic modulated symbols of the signal for retransmission is different from that used to obtain the basic modulated symbols of the transmitted signal; and
a transmitting module, configured to transmit the signal for retransmission to the terminal.

19. The ARSM apparatus of claim 18, wherein the angle rotational superposing module comprises:
two basic modulating units, configured to modulate input bit streams of the transmitted signal with a same modulation scheme according to the indication received by the receiving module to obtain basic modulated symbols;
two phase shifting units, configured to perform phase shift on the basic modulated symbols of the input bit streams of the transmitted signal of two layers with phase-shift factors, wherein the phase-shift factors are different from those used to obtain the transmitted signal, to obtain modulated symbols of the input bit streams of the transmitted signal of the two layers; and
a superposing unit, configured to superpose the phase-shifted modulated symbols of the input bit streams of the transmitted signal of the two layers and transmit the superposed symbols to the terminal.

20. The ARSM apparatus of claim 18, wherein the angle rotational superposing module further comprises a serial-parallel converting unit, configured to perform serial-parallel conversion on the input bit streams of the transmitted signal and distribute the converted bit streams to the basic modulating units.
